(19) United States
(12) Patent Application Publication
(10) Pub. No.: US 2024/0083677 A1
(43) Pub. Date: Mar. 14, 2024

(54) APPARATUS AND ITS OPERATION METHOD OF SALT CAVERN GAS STORAGE WITHOUT CUSHION GAS

(71) Applicant: INSTITUTE OF ROCK AND SOIL MECHANICS, CHINESE ACADEMY OF SCIENCES, Wuhan City (CN)

(72) Inventors: Xilin SHI, Wuhan City (CN); Xinxing WEI, Wuhan City (CN); Yinping LI, Wuhan City (CN); Hongling MA, Wuhan City (CN); Peng LI, Wuhan City (CN); Chunhe YANG, Wuhan City (CN); Weizheng BAI, Wuhan City (CN)

(73) Assignee: INSTITUTE OF ROCK AND SOIL MECHANICS, CHINESE ACADEMY OF SCIENCES, Wuhan City (CN)

(21) Appl. No.: 18/052,917

(22) Filed: Nov. 5, 2022

(30) Foreign Application Priority Data
Sep. 9, 2022 (CN) 202211104052.4

(51) Int. Cl. E21F 17/16

(52) U.S. Cl. CPC E21F 17/16

(57) ABSTRACT

An apparatus of salt cavern gas storage without cushion gas includes: a salt cavern; sediments; a drainage assembly; a gas injection and production pipe; a debrining string, one end of which is connected to the drainage assembly, and the other end of which protrudes from the ground to be connected to a water source assembly; a communicating assembly, which is used to make the gas injection and production pipe be in communication with the debrining string on the ground. A closed loop is formed by making the gas injection and production pipe and the debrining string be in communication with each other on the ground through the communicating assembly, thus the non-cushion gas injection-production operation of sediment particles in the salt cavern is realized.

### CROSS-REFERENCE TO RELATED APPLICATION

The present disclosure claims priority to Chinese Patent Application No. 202211104052.4 filed on Sep. 9, 2022, the disclosure of which is hereby incorporated by reference in its entirety.

### BACKGROUND

Salt rocks are internationally recognized as underground energy storage sites, because of their good creep and damage recovery properties. China has clearly proposed to build national energy storage centers through salt cavern storages and has already established salt cavern building projects in many places, such as Jiangsu Jintan and Huai'an, Shandong Tai'an, Hubei Qianjiang and Yingcheng, etc. In addition, China is rich in salt resources and has favorable conditions for the construction of salt cavern storages.

So far, the mining method for salt mine is mainly the method of solution mining and horizontal butted well drilling, which injects gas and discharges brine through the salt cavern after solution mining so as to achieve the gas storage function of the salt cavern. This is of great significance to increase the national overall energy storage capacity and improve the national energy storage system.

Meanwhile, the sedimentary characteristics of lacustrine facies of salt rocks in China lead to a large number of interlayers in salt mines and high insoluble impurities in interlayers. Therefore, after solution mining, a large amount of insoluble residues will be produced at the bottom of the salt cavern. These insoluble residues will seriously affect the gas storage function of salt cavern gas storage groups, and even in areas of salt mines with high impurity, the salt cavern after solution mining will become a waste cavern because of too many insoluble residues. Except for the impact of sediment particles on the gas storage efficiency, traditional salt cavern gas storage groups have to ensure a certain minimum allowable storage pressure during operation. Thus, there will be left a portion of cushion gas inside the salt cavern, and the portion of cushion gas cannot be produced and thus wasted.

To sum up, sediment particles in a salt cavern after solution mining will reduce the storage capacity of the salt cavern, affecting the normal gas injection and production operations of the salt cavern. The volume of the salt cavern occupied by the sediment particles will also result in decreasing the storage value of the salt cavern. Further, gaps among sediment particles will be filled with brine, which cannot be produced, thus the gaps and brine in gaps are not utilized, and the minimum allowable storage pressure during gas injection and production in the salt cavern causes the cushion gas inside the salt cavern to remain undischarged.

### SUMMARY

The disclosure relates to the technical fields of solution mining of salt mines and sediment gas storage of salt cavern gas storage groups, and in particular to an apparatus and its operation method of salt cavern gas storage without cushion gas.

An objective of the disclosure is to provide an apparatus and its operation method of salt cavern gas storage without cushion gas, so as to solve the technical problem in some implementations, that is, a portion of cushion gas is left inside a salt cavern and cannot be produced.

To solve the above technical problem, the disclosure proposes technical solutions as follows.

In a first aspect of the disclosure, an apparatus of salt cavern gas storage without cushion gas is provided, which may include: a salt cavern, which is located underground; sediments, which is inside the salt cavern, and gaps of the sediments are used to store natural gas; a drainage assembly, which is used to discharge brine in the sediments from a lower end of the salt cavern; a gas injection and production pipe, a lower end of which is in communication with an upper end of the salt cavern, and an upper end of which protrudes from the ground to be connected to a gas source assembly; a debrining string, one end of which is connected to the drainage assembly, and the other end of which protrudes from the ground to be connected to a water source assembly; a communicating assembly, which is used to make the gas injection and production pipe be in communication with the debrining string on the ground.

In some embodiments, the drainage assembly comprises a horizontal channel. The horizontal channel is provided at the bottom of the salt cavern and connected to a lower end of the debrining string.

In some embodiments, the communicating assembly comprises a first communicating pipe and an isolation valve, wherein the first communicating pipe is used to make the gas injection and production pipe be in communication with the debrining string on the ground, and the isolation valve is provided in the first communicating pipe.

In some embodiments, the gas source assembly comprises a gas injection and production unit and a main valve, the gas injection and production unit being connected to an upper end of the gas injection and production pipe, and the main valve being provided at the gas injection and production unit.

In some embodiments, the water source assembly comprises a debrining unit and a debrining string valve, the debrining unit being connected to an upper end of the debrining string, and the debrining string valve being provided at the debrining unit.

In some embodiments, a gas injection-exhaust pipe valve is provided on the gas injection and production pipe.

In some embodiments, two salt caverns are provided.

In some embodiments, the lower ends of the two salt caverns are horizontally connected through the horizontal channel.

In some embodiments, the upper ends of the two salt caverns are both provided with gas injection and production pipes, the two gas injection and production pipes being in communication with each other through a second communicating pipe, and an upper end of the second communicating pipe being connected to the gas source assembly.

In a second aspect of the disclosure, an operation method of an apparatus of salt cavern gas storage without cushion gas, comprising the following steps:
during gas injection, opening a main valve, a debrining string valve and a gas injection-exhaust pipe valve, closing an isolation valve, injecting natural gas into a salt cavern through a gas injection and production pipe to displace brine in sediments, and then the brine entering the injection-drainage pipe through a horizontal channel to be discharged; after the brine is completely discharged, closing the main valve and the debrining string valve, and opening the isolation valve, thus gas injection and storage is completed; and
during gas discharging, opening the main valve, the debrining string valve and the gas injection-exhaust pipe valve, closing the isolation valve, injecting brine from the debrining string and then the brine entering the bottom of the salt cavern through the horizontal channel, so that the natural gas inside the salt cavern is displaced and continuously discharged upward from gaps of the sediments, moves upward to reach the gas injection and production pipe and then is discharged through the main valve.

It can be seen from the foregoing technical solutions, the disclosure at least has the following advantages and positive effects.

With an apparatus and its operation method of salt cavern gas storage without cushion gas in the disclosure, a closed loop is formed by making a gas injection and production pipe and a debrining string be in communication with each other on the ground through a communicating assembly, and the non-cushion gas injection-production operation of sediment particles in the salt cavern is realized. The proposed mode of operation can increase the utilization efficiency of the salt cavern and usage efficiency of gaps in sediment particles, i.e., the utilization efficiency of the salt cavern is increased up to 80% to 90%. Therefore, the gas storage content of the salt cavern is significantly improved, and the risk of salt caverns being discarded due to excessive sediments is reduced, and further there is a high economic value.

### BRIEF DESCRIPTION OF THE DRAWINGS

To more clearly illustrate the technical solutions of embodiments of the disclosure, a brief introduction is presented below to the accompanying drawings used in the description of the embodiments. It is apparent that the drawings to be described below are merely some embodiments of the disclosure. Those of ordinary skill in the art may further obtain other drawings according to these drawings without creative labor.

FIG. 1 shows a flowchart of a process of an operation method of an apparatus of salt cavern gas storage without cushion gas according to an embodiment of the disclosure;

FIG. 2 shows a structural diagram of an apparatus of salt cavern gas storage without cushion gas during gas injection stage of individual salt cavern of a horizontal butted well according to an embodiment of the disclosure;

FIG. 3 shows a structural diagram of an apparatus of salt cavern gas storage without cushion gas during gas storage stage of individual salt cavern of a horizontal butted well according to an embodiment of the disclosure;

FIG. 4 shows a structural diagram of an apparatus of salt cavern gas storage without cushion gas during gas production stage of individual salt cavern of a horizontal butted well according to an embodiment of the disclosure;

FIG. 5 shows a structural diagram of an apparatus of salt cavern gas storage without cushion gas during gas injection stage of double salt caverns of a horizontal butted well according to an embodiment of the disclosure;

FIG. 6 shows a structural diagram of an apparatus of salt cavern gas storage without cushion gas during gas storage stage of double salt caverns of a horizontal butted well according to an embodiment of the disclosure; and

FIG. 7 shows a structural diagram of an apparatus of salt cavern gas storage without cushion gas during gas production stage of double salt caverns of a horizontal butted well according to an embodiment of the disclosure.

Explanations of Reference Numerals: 1. gas injection-exhaust pipe valve; 2. gas injection and production pipe; 3. first communicating pipe; 4. salt cavern; 5. sediment; 6. horizontal channel; 7. debrining string; 8. debrining string valve; 9. isolation valve; 10. main valve; 11. gas-liquid interface; 12. gas injection and production unit; 13. debrining unit; 14. second communicating pipe.

### DETAILED DESCRIPTION

The technical solutions in embodiments of the disclosure will be clearly and completely described in conjunction with the drawings. It is apparent that the embodiments to be described are merely a part not all of the embodiments of the disclosure. All other embodiments obtained by those of ordinary skill in the art based on the embodiments of the disclosure without creative labor fall within the protection scope of the disclosure.

In the description of the disclosure, it should be appreciated that orientation or positional relationships indicated by the terms “center,” “upper,” “lower,” “front,” “back,” “left,” “right,” “vertical,” “horizontal,” “top,” “bottom,” “inside” and “outside” are merely orientation or positional relationships shown in the accompanying drawings, and they are intended for the purposes of describing the disclosure and simplifying the description, rather than suggesting or hinting that the device or element mentioned must have a particular orientation or be constructed and operated in a particular orientation, and therefore cannot be construed as limiting the disclosure.

The terms “first,” “second” and “third” are merely intended for the description purpose and should not be construed as suggesting or hinting relative importance or implicitly indicating the number of technical features mentioned. Therefore, features defined by “first,” “second” and “third” may explicitly or implicitly include one or more of the features. In the description of the disclosure, “multiple” means two or more, unless otherwise specified.

In the description of the disclosure, it is noteworthy that unless otherwise expressly specified and defined, the terms “in communication with,” “mount,” “connected with” and “connected to” should be understood in a broad sense. For example, they may be a fixed connection, a removable connection, or an integral connection; they may be a mechanical connection or an electrical connection; they may be directly connected or connected through an intermediate medium, and they may be communication in two elements. Those of ordinary skill in the art may understand the specific meaning of these terms in the disclosure according to specific situation.

### First Embodiment

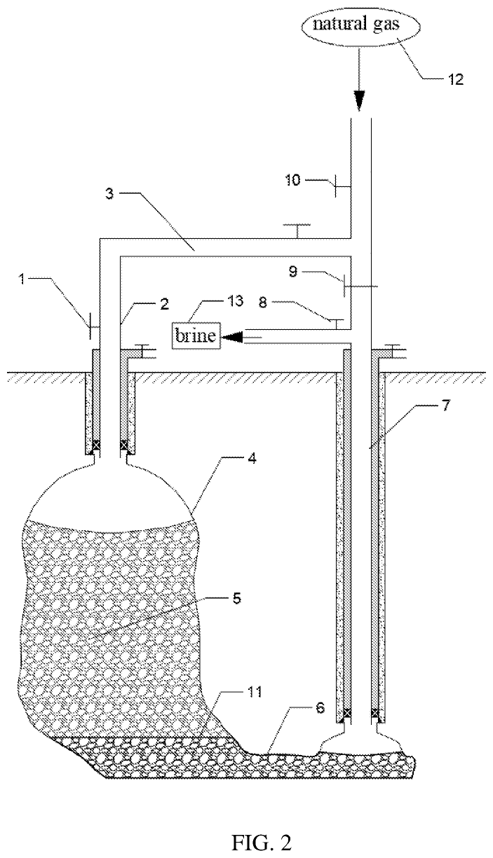

Reference is made to FIGS. 2-4.

FIGS. 2-4 show a structural diagram of an apparatus of salt cavern gas storage without cushion gas according to an embodiment of the disclosure. As depicted, the apparatus may include: a salt cavern 4, the salt cavern 4 being located underground; sediments 5, the sediments 5 being inside the salt cavern 4, gaps of the sediments 5 being used to store natural gas; a drainage assembly, the drainage assembly being used to drain brine in the sediments 5 from a lower end of the salt cavern 4; a gas injection and production pipe 2, a lower end of the gas injection and production pipe 2 being in communication with an upper end of the salt cavern 4, and an upper end of the gas injection and production pipe 2 protruding from the ground to be connected to a gas source assembly; a debrining string 7, one end of the debrining string 7 being connected to the drainage assembly, and the other end of the debrining string 7 protruding from the ground to be connected to a water source assembly; a communicating assembly, the communicating assembly being used to make the gas injection and production pipe 2 be in communication with the debrining string 7 on the ground. By making the gas injection and production pipe 2 be in communication with the debrining string 7 on the ground through the communicating assembly, a closed loop is formed, thereby realizing the non-cushion gas injection-production operation of particle gaps of the sediments 5 in the salt cavern.

In some embodiments, one salt cavern 4 is provided.

In some embodiments, the drainage assembly includes a horizontal channel 6. The horizontal channel 6 is provided at the bottom of the salt cavern 4 and in communication with a lower end of the debrining string 7.

In some embodiments, the communicating assembly includes a first communicating pipe 3 and an isolation valve 9. The first communicating pipe 3 is used to make the gas injection and production pipe 2 be in communication with the debrining string 7 on the ground, and the isolation valve 9 is provided in the first communicating pipe 3.

In some embodiments, the gas source assembly includes a gas injection and production unit 12 and a main valve 10. The gas injection and production unit 12 is connected to the upper end of the gas injection and production pipe 2, and the main valve 10 is provided on the gas injection and production unit 12.

In some embodiments, the water source assembly includes a debrining unit 13 and a debrining string valve 8. The debrining unit 13 is connected to an upper end of the debrining string 7, and the debrining string valve 8 is provided on the debrining unit 13.

In some embodiments, a gas injection-exhaust pipe valve 1 is provided on the gas injection and production pipe 2.

In some embodiments, a gas-liquid interface 11 exists between natural gas and brine. This refers to a partition interface between natural gas and brine in the gas-injection brine-discharge stage. This partition interface is usually located at the bottom of the salt cavern 4.

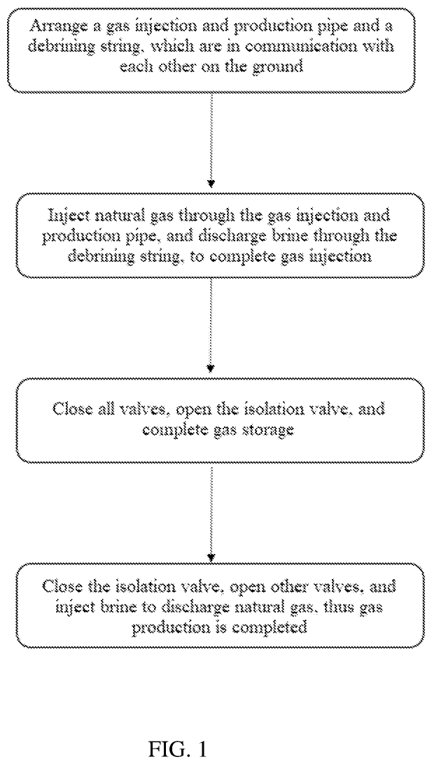

Please refer to FIG. 1, which is a flowchart of a process of an operation method of an apparatus of salt cavern gas storage without cushion gas according to some embodiments of the disclosure. A production and operation method of individual salt cavern in a horizontal butted well by the apparatus of salt cavern gas storage without cushion gas is provided in the present embodiment. The method includes the following steps:

Please refer to FIG. 2.

During gas injection, the main valve 10, the debrining string valve 8 and the gas injection-exhaust pipe valve 1 are opened, and the isolation valve 9 is closed, thus natural gas is injected into the salt cavern 4 through the gas injection and production pipe 2 and displaces brine in the sediment 5, and the brine enters the debrining string 7 through the horizontal channel 6 to be discharged; with the continuous injection of natural gas, the gas-liquid interface 11 keeps falling, and finally all brine in gaps of the sediments 5 are discharged.

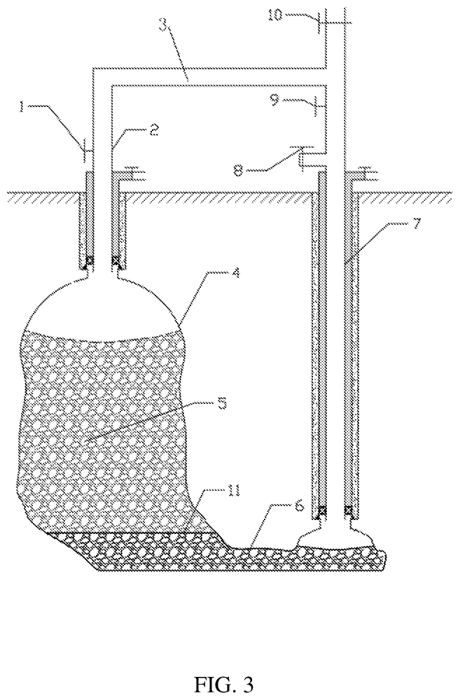

Please refer to FIG. 3.

After all brine is completely discharged, the main valve 10 and the debrining string valve 8 are closed, and the isolation valve 9 is opened, and thus gas injection and storage is completed; at this point, gaps of the sediments 5 at the bottom of the salt cavern 4 forms a closed-loop storage system with the gas injection and production pipe 2 and the debrining string 7. Thus, the closed-loop storage of natural gas in the pipes and gaps of the sediments in the salt cavern 4 is realized.

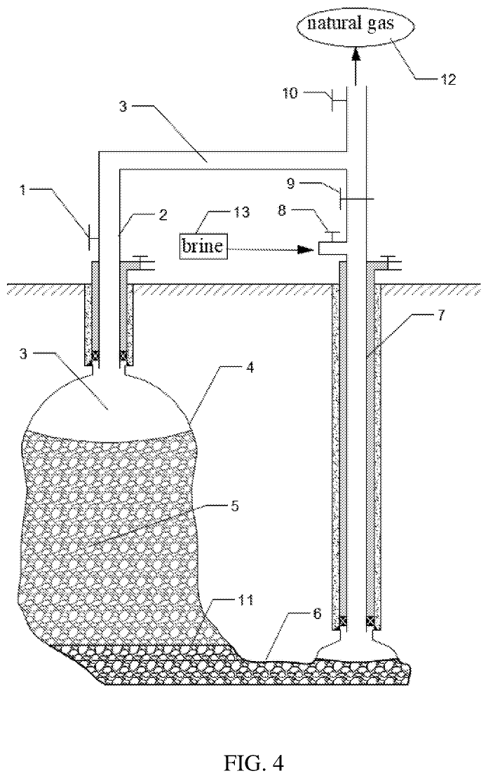

Please refer to FIG. 4.

During gas discharging, the main valve 10, the debrining string valve 8 and the gas injection-exhaust pipe valve 1 are opened, and the isolation valve 9 is closed, brine is injected from the debrining string 7, and the brine enters the bottom of the salt cavern 4 through the horizontal channel 6, so that natural gas inside the salt cavern 4 is displaced, is continuously discharged upward from gaps of the sediments 5, moves upward to reach the gas injection and production pipe 2 and then is discharged through the main valve 10.

When the space in the salt cavern 4 is filled with brine, the natural gas is completely produced. At this point, the gas-liquid interface 11 keeps rising with the continuous injection of brine. Since the debrining string 7 and the gas injection and production pipe 2 are in direct communication with the ground, there is no cushion gas in the whole process, and all natural gas can be produced.

### Second Embodiment

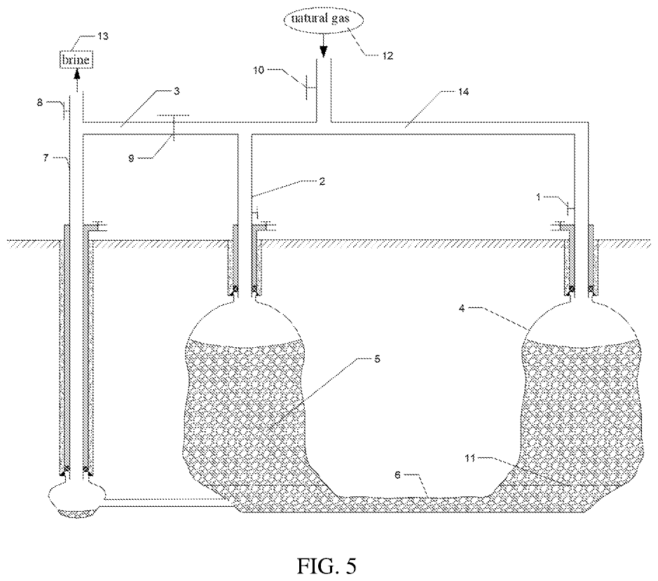

The present embodiment is the same as the first embodiment in addition to the following distinguishing features. With reference to FIGS. 5-7, the present embodiment provides a production and operation method of double salt caverns in a horizontal butted well by the apparatus of salt cavern gas storage without cushion gas is provided in the present embodiment.

In some embodiments, two salt caverns 4 are provided. Lower ends of the two salt caverns 4 are in communication with each other through the horizontal channel 6. Brine in gaps between particles of the sediments 5 need to be discharged by entering the debrining string 7 through the horizontal channel 6.

In some embodiments, an upper end of each of the two salt caverns 4 is provided with the gas injection and production pipe 2. The upper ends of the two gas injection and production pipes 2 are in communication with each other through a second communicating pipe 14, and an upper end of the second communicating pipe 14 is connected to the gas injection and production unit 12.

A production and operation method of a production and operation apparatus of a double salt cavern 4 sediment 5 gap-type salt cavern gas storage is provided in the present embodiment, including the following steps:

Please refer to FIG. 5.

During gas injection, the main valve 10, the debrining string valve 8 and the gas injection-exhaust pipe valves 1 above the two salt caverns 4 are opened, and the isolation valve 9 is closed, thus the natural gas enters the two gas injection and production pipes 2 through a gas injection and production unit 12 to be respectively injected into the two salt caverns 4 and displaces brine in the sediments 5, and the brine enters the debrining string 7 through the horizontal channel 6 to be discharged. With the continuous injection of natural gas, the gas-liquid interface 11 keeps falling, and finally all brine in gaps of the sediments 5 are discharged.

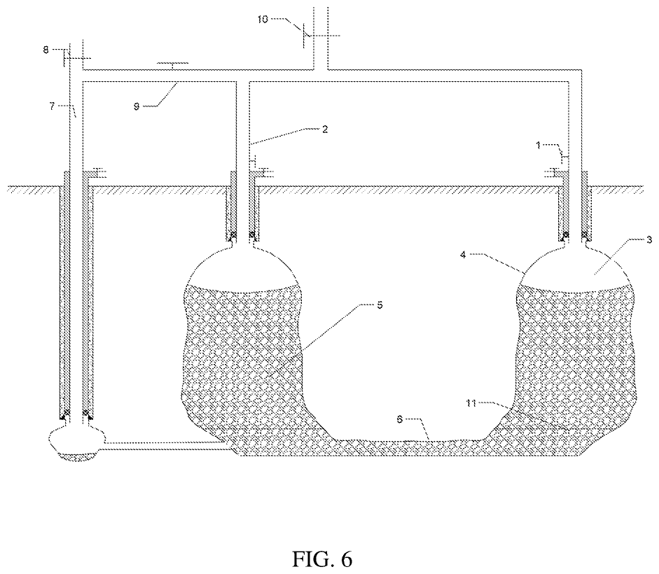

Please refer to FIG. 6.

After all brine is completely discharged, the main valve 10 and the water injection and drainage pipe valve 8 are closed, and the isolation valve 9 is opened, and thus gas injection and storage is completed. At this point, gaps of the sediments 5 at the bottom of the salt caverns 4 form a closed-loop storage system with the gas injection and production pipes 2 and the debrining string 7. Thus, a closed-loop storage of natural gas in the pipes and gaps of the sediments in the salt caverns 4 is realized.

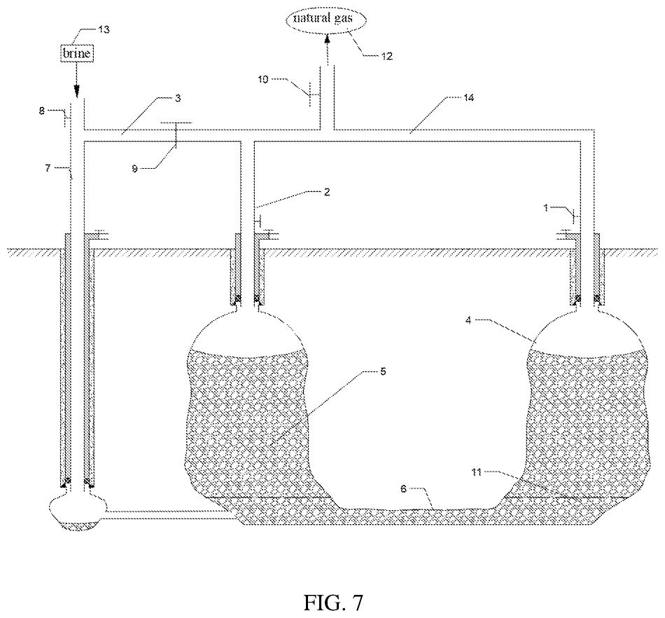

Please refer to FIG. 7.

During gas discharging, the main valve 10, the debrining string valve 8 and the gas injection-exhaust pipe valves 1 above the two salt caverns 4 are opened, and the isolation valve 9 is closed, the brine is injected from the debrining string 7, and then the brine enters the bottom of each of the two salt caverns 4 through the horizontal channel 6, so that the natural gas inside the salt caverns 4 are displaced, are continuously discharged upward from gaps of the sediments 5, move upward to reach the gas injection and production pipes 2 and then are discharged through the main valve 10. When the spaces in the salt caverns 4 are filled with brine, the natural gas is completely produced. At this point, the gas-liquid interface 11 keeps rising with the continuous injection of brine. Since the debrining string 7 and the gas injection and production pipe 2 are in direct communication with the ground, there is no cushion gas in the whole process, and all natural gas can be produced.

It can be seen from the foregoing technical solutions, the disclosure at least has the following advantages and positive effects.

With the apparatus and its operation method of salt cavern gas storage without cushion gas in the disclosure, a closed loop is formed by making the gas injection and production pipe and the debrining string be in communication with each other on the ground through the communicating assembly, and the non-cushion gas injection-production operation of sediment particles in the salt cavern is realized. The proposed mode of operation can increase the utilization efficiency of the salt cavern and usage efficiency of gaps in sediment particles, i.e., the utilization efficiency of the salt cavern is increased up to 80% to 90%. Therefore, the gas storage content of the salt cavern is significantly improved, and the risk of salt caverns being discarded due to excessive sediments is reduced, and further there is a high economic value.

In the foregoing description of the implementations, specific features, structures, material or characteristics may be combined in an appropriate way in any one or more embodiments or examples.

Specific implementations of the disclosure have been described above. However, the protection scope of the disclosure is not limited thereto. Changes or replacements which can be easily devised by any skilled in the art within the disclosed technical scope should be included in the protection scope of the disclosure. Therefore, the protection scope of the disclosure should be defined by the claims.

What is claimed is:

1. An apparatus of salt cavern gas storage without cushion gas, comprising:
a salt cavern, which is located underground;
sediments, which is inside the salt cavern, and gaps of the sediments are used to store natural gas;
a drainage assembly, which is used to discharge brine in the sediments from a lower end of the salt cavern;
a gas injection and production pipe, a lower end of which is in communication with an upper end of the salt cavern, and an upper end of which protrudes from the ground to be connected to a gas source assembly;
a debrining string, one end of which is connected to the drainage assembly, and the other end of which protrudes from the ground to be connected to a water source assembly;
a communicating assembly, which is used to make the gas injection and production pipe be in communication with the debrining string on the ground.

2. The apparatus of salt cavern gas storage without cushion gas according to claim 1, wherein the drainage assembly comprises a horizontal channel, and wherein the horizontal channel is provided at the bottom of the salt cavern and connected to a lower end of the debrining string.

3. The apparatus of salt cavern gas storage without cushion gas according to claim 1, wherein the communicating assembly comprises a first communicating pipe and an isolation valve, wherein the first communicating pipe is used to make the gas injection and production pipe be in communication with the debrining string on the ground, and the isolation valve is provided in the first communicating pipe.

4. The apparatus of salt cavern gas storage without cushion gas according to claim 1, wherein the gas source assembly comprises a gas injection and production unit and a main valve, the gas injection and production unit being connected to an upper end of the gas injection and production pipe, and the main valve being provided at the gas injection and production unit.

5. The apparatus of salt cavern gas storage without cushion gas according to claim 1, wherein the water source assembly comprises a debrining unit and a debrining string valve, the debrining unit being connected to an upper end of the debrining string, and the debrining string valve being provided at the debrining unit.

6. The apparatus of salt cavern gas storage without cushion gas according to claim 1, wherein a gas injection-exhaust pipe valve is provided on the gas injection and production pipe.

7. The apparatus of salt cavern gas storage without cushion gas according to claim 2, wherein two salt caverns are provided.

8. The apparatus of salt cavern gas storage without cushion gas according to claim 7, wherein the lower ends of the two salt caverns are connected through the horizontal channel.

9. The apparatus of salt cavern gas storage without cushion gas according to claim 7, wherein the upper ends of the two salt caverns are both provided with gas injection and production pipes, the two gas injection and production pipes being in communication with each other through a second communicating pipe, and an upper end of the second communicating pipe being connected to the gas source assembly.

10. An operation method of an apparatus of salt cavern gas storage without cushion gas, comprising the following steps:
during gas injection, opening a main valve, a debrining string valve and a gas injection-exhaust pipe valve, closing an isolation valve, injecting natural gas into a salt cavern through a gas injection and production pipe to displace brine in sediments, and then the brine entering the injection-drainage pipe through a horizontal channel to be discharged; after brine is completely discharged, closing the main valve and the debrining string valve, and opening the isolation valve, thus gas injection and storage is completed; and
during gas discharging, opening the main valve, the debrining string valve and the gas injection-exhaust pipe valve, closing the isolation valve, injecting brine from the debrining string and then the brine entering the bottom of the salt cavern through the horizontal channel, so that the natural gas inside the salt cavern is displaced and continuously discharged upward from gaps of the sediments, moves upward to reach the gas injection and production pipe and then is discharged through the main valve.
